(19) United States
(12) Patent Application Publication
(10) Pub. No.: US 2013/0107116 A1
(43) Pub. Date: May 2, 2013

(54) Apparatus and Method for Communication

(71) Applicants: Gilles Charbit, Farnborough (GB); Tao Chen, Salo (FI)

(72) Inventors: Gilles Charbit, Farnborough (GB); Tao Chen, Salo (FI)

(73) Assignee: Renesas Mobile Corporation

(21) Appl. No.: 13/286,354

(22) Filed: Nov. 1, 2011

(30) Foreign Application Priority Data
Oct. 28, 2011 (GB) GB118708.5

(51) Int. Cl. H04N 7/12; H04W 72/00

(52) U.S. Cl. 348/388.1; 370/329; 348/E07.045

(57) ABSTRACT

Apparatus and method for communication are provided. The solution includes controlling a transceiver to determine free frequency blocks on a shared spectrum and controlling a transceiver to map synchronization control channels, downlink and uplink physical control channels, physical broadcast channel and random access channel on found free frequency blocks.

### CROSS REFERENCE TO RELATED APPLICATION

This application claims benefit under 35 U.S.C. §119(a) and 37 CFR 1.55 to UK Patent Application GB1118708.5, filed on Oct. 28, 2011.

### FIELD

The exemplary and non-limiting embodiments of the invention relate generally to wireless communication networks. Embodiments of the invention relate especially to an apparatus and a method in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

With the ever increasing demand for increasing data rates and higher quality services in the world of mobile communications comes ever increasing demand for better performance of cellular network infrastructures. The increased spectrum requirements due the increased data traffic drives operators seek offloading solutions for their traffic via local nodes providing local access to the Internet to prevent congesting own core network. A wide variety of diverse size of cells and connected devices are proposed in addition to traditional macro and microcells. However, the available frequency resources are limited and need for efficient use of the resources is essential.

Traditional solutions to improve spectrum efficiency cannot support the predicted data traffic in the future. Thus, operators, network and device manufacturers and other players in the field are considering the utilization of license-exempt (LE) or unlicensed frequency bands along with costly licensed spectrum. The LE spectrum can also be called as shared spectrum. Shared spectrum is only lightly regulated; users do not need licenses to exploit them. From the cellular traffic point of view, an interesting shared spectrum band opportunity is Industrial, Scientific and Medical (ISM) bands. The ISM bands are widely used for WLAN and Bluetooth® communication. The ISM bands allow both standardized systems and proprietary solutions to be deployed onto spectrum as far as regulations are followed. The regulations define maximum transmission powers and certain rules for the hopping based systems for the operation on the band.

For example, the potential use of television white spaces has been investigated widely in the recent years, due to their available large bandwidths at suitable frequencies for different radio applications. For example in the United States, the Federal Communications Commission (FCC) have regulated licensed or license-exempt TV bands for the secondary-system applications such as cellular communication, wireless local area network channels (WiFi, WLAN) and Worldwide Interoperability for Microwave Access (WiMax).

Currently it is challenging to for many cellular systems such as the third and fourth generation systems long term evolution (LTE, known also as E-UTRA) and long term evolution advanced (LTE-A) to utilize LE bands for example due to required continuous and synchronous resource allocation for control channels both in downlink and uplink transmission directions.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus in a communication system, comprising: at least one processor; and at least one memory including computer program code, the at least one memory and the computer program code configured to, with the at least one processor, cause the apparatus at least to perform: control a transceiver to determine free frequency blocks on a shared spectrum; control a transceiver to map synchronization control channels, downlink and uplink physical control channels, physical broadcast channel and random access channel on found free frequency blocks.

According to another aspect of the present invention, there is provided a method in a communication system comprising: controlling a transceiver to determine free frequency blocks on a shared spectrum and controlling a transceiver to map synchronization control channels, downlink and uplink physical control channels, physical broadcast channel and random access channel on found free frequency blocks.

### LIST OF DRAWINGS

Embodiments of the present invention are described below, by way of example only, with reference to the accompanying drawings, in which

FIG. 1 illustrates an example of a communication environment;

FIG. 2 illustrates an example of a device applying embodiments of the invention;

FIG. 3 illustrates an example of the use of fractional free TV resources for control channels;

FIG. 4 illustrates an embodiment of the invention;

FIGS. 5 and 6 are flowcharts illustrating embodiments of the invention; and

FIG. 7 illustrates an example of a device applying embodiments of the invention.

### DESCRIPTION OF SOME EMBODIMENTS

Embodiments are applicable to any base station, user equipment (UE), server, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN or E-UTRAN), long term evolution (LTE, known also as E-UTRA), long term evolution advanced (LTE-A), Wireless Local Area Network (WLAN) based on IEEE 802.11 standard, worldwide interoperability for microwave access (WiMAX), Bluetooth®, personal communications services (PCS) and systems using ultra-wideband (UWB) technology. IEEE refers to the Institute of Electrical and Electronics Engineers. LTE and LTE-A are developed by the Third Generation Partnership Project 3GPP.

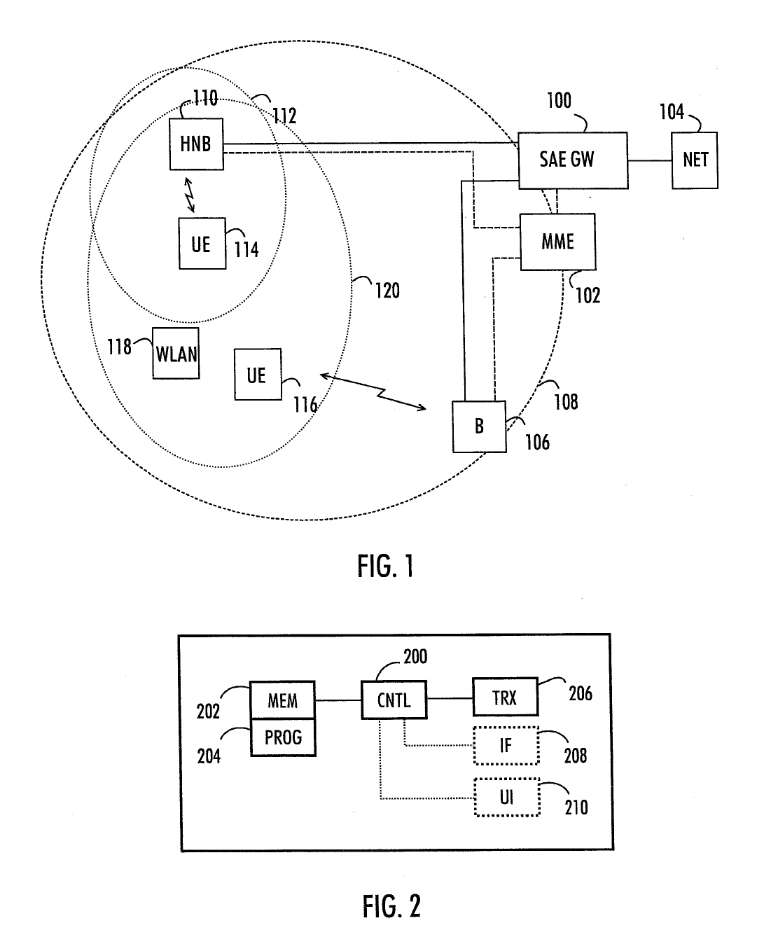

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

In the example of FIG. 1, a radio system based on LTE/SAE (Long Term Evolution/System Architecture Evolution) network elements is shown. However, the embodiments described in these examples are not limited to the LTE/SAE radio systems but can also be implemented in other radio systems.

The simplified example of a network of FIG. 1 comprises a SAE Gateway 100 and an MME 102. The SAE Gateway 100 provides a connection to Internet 104. FIG. 1 shows an eNodeB 106 serving a macro cell 108. In addition, a local area base stations or Home NodeB HNB 110 with a corresponding coverage area 112 is shown. In this example, the Home NodeB 110 and the eNodeB 106 are connected to the SAE Gateway 100 and the MME 102.

In the example of FIG. 1, user equipment UE 114 is camped on the HNB 110. The UE 116 is camped on the eNodeB 106. Furthermore, a wireless local area (WLAN) base station 118 is transmitting with a coverage area 120.

The eNodeBs (Enhanced node Bs) of a communication system may host the functions for Radio Resource Management: Radio Bearer Control, Radio Admission Control, Connection Mobility Control, Dynamic Resource Allocation (scheduling). The MME 102 (Mobility Management Entity) is responsible for the overall UE control in mobility, session/call and state management with assistance of the eNodeBs through which the UEs connect to the network. The SAE GW 100 is an entity configured to act as a gateway between the network and other parts of communication network such as the Internet for example. The SAE GW may be a combination of two gateways, a serving gateway (S-GW) and a packet data network gateway (P-GW).

User equipment UE refers to a portable computing device. Such computing devices include wireless mobile communication devices operating with or without a subscriber identification module (SIM), including, but not limited to, the following types of devices: mobile phone, smartphone, personal digital assistant (PDA), handset, laptop computer.

In an embodiment, at least some of the above connections between NodeB's and UEs utilise an unlicensed or shared spectrum which may be the same as the spectrum used by the WLAN base station 118.

The regulations applying to the usage of shared spectrum require different systems to use the available resources in a fair manner without causing excessive interference to other systems using the same resources.

In an embodiment, Listen-Before-Talk (LBT) or channel contention between the devices communicating on the shared spectrum is used to reduce interference. LBT or channel contention may require a device to listen, monitor or measure the usage of a channel for a given time before making the decision whether to transmit on the channel or not. In an embodiment, the device may monitor energy level on a channel and if the level is above a given threshold it may determine that the channel is in use by another device. If the channel or spectrum is used by another device the transmitter is configured to abstain from transmitting or select a different channel.

As most cellular systems require that control channel trans-missions are continuous and synchronous the restricted use of resources on shared spectrum is challenging as the resource allocation for control channels both in downlink and uplink transmission directions is problematic. In addition, if LBT type of channel access is utilized, the resource allocation for synchronization signals, critical control channel signaling like HARQ (Hybrid automatic repeat request) feedback is challenging as there is no certainty that resources for the required HARQ feedback for the earlier data transmission can be obtained.

In LTE based systems, some of the control channels essential for the operation of the network include Physical Broadcast Channel PBCH, Primary Synchronization Channel PSS, and Secondary Synchronization Channel SSS. Examples of other relevant common and dedicated control channels are Physical Control Format Indicator Channel PCFICH, Physical Downlink Control Channel PDCCH, Physical HARQ Indicator Channel PHICH, Physical Uplink Shared Channel PUSCH, and Physical Downlink Control Channel PDCCH.

FIG. 2 illustrates an embodiment. The figure illustrates a simplified example of a device in which embodiments of the invention may be applied. In some embodiments, the device may be a base station or an eNodeB of a communications system.

It should be understood that the device is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 200 configured to control at least part of the operation of the device.

The device may comprise a memory 202 for storing data. Furthermore the memory may store software 204 executable by the control circuitry 200. The memory may be integrated in the control circuitry.

The device comprises a transceiver 206. The transceiver is operationally connected to the control circuitry 200. It may be connected to an antenna arrangement (not shown).

The software 204 may comprise a computer program comprising program code means adapted to cause the control circuitry 200 of the device to control a transceiver 206 to determine free frequency blocks on a shared spectrum and control the transceiver to map synchronization control channels, downlink and uplink physical control channels, physical broadcast channel and random access channel on found free frequency blocks.

The device may further comprise interface circuitry 208 configured to connect the device to other devices and network elements of a communication system, for example to core. This applies especially if the device is an eNodeB or a base station or respective network element. The interface may provide a wired or wireless connection to the communication network. The device may be in connection with core network elements, eNodeB's, Home NodeB's and with other respective devices of communication systems.

The device may further comprise user interface 210 operationally connected to the control circuitry 200. The user interface may comprise a display, a keyboard or keypad, a microphone and a speaker, for example.

In an embodiment, fractional free resources of shared spectrum are used for control channels transmission. For example, fractional free resources of the television white spaces (TVWS) may be used for LTE system setup and operation in the presence of WLAN-based systems. In some proposal, television channel transmissions require a 6 MHz band. WLAN transmission utilizing TVWS may use a 5 MHz band. Thus, 1 MHz frequency resources are not utilized by such WLAN systems and they are also difficult for the deployment of any other infrastructure based system. However, embodiments of the invention are not limited to the scenario where a 5 MHz WLAN-based system is operating on a 6 MHz TV channel. Any scenario with the fractional free resources can be applied.

In an embodiment, the purpose is to find the free fractional resources of television channels for the operation of essential control channels. Other resources for the data channel access may be determined in an opportunistic way or using a reusing approach. In addition, load/admission control can be operated via the enhanced closed subscriber group CSG solution to keep the system operating in a suitable load with the limited resources control/data resources.

In following examples, Time Division Duplex transmission mode is assumed.

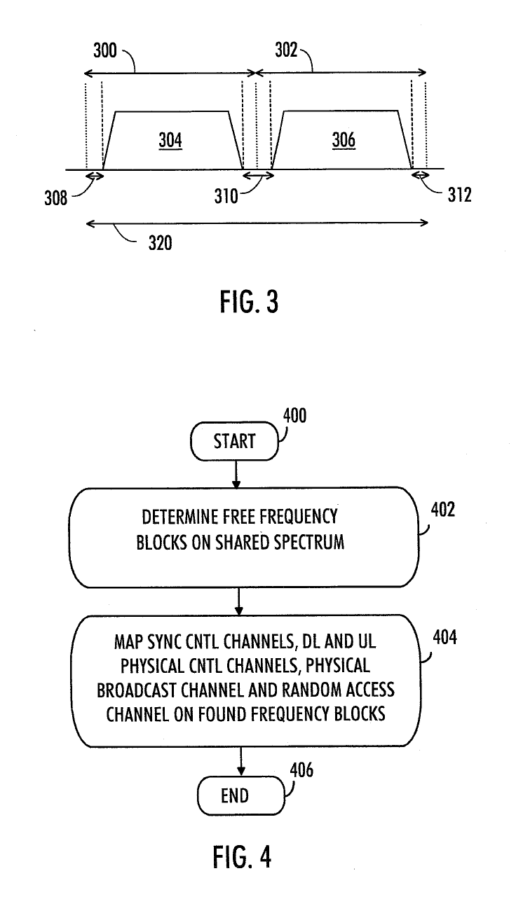

FIG. 3 illustrates an example of the use of fractional free TV resources for essential control channels. FIG. 3 shows two TV channels 300, 302 each having a 6 MHz bandwidth. Each TV channel may have a 5 MHz WLAN channel reservation or designation 304, 306 on which a WLAN transmission may occur if the channel is not on TV use. This leaves the edge areas 308, 310, 312 free for other use. The edge areas 308 and 312 are 0.5 MHz wide and the combined area 310 is 1 MHz wide. The combined bandwidth of the two TV channels is 12 MHz.

In an embodiment, a fraction of TV channels not used by WLAN-based system are exploited for the clean LTE control channels via layered sensing scheme. In addition, TVWS database lookup may be utilized.

In layered sensing, a transceiver is configured to sense the bands 308, 310, 312 at the two ends of each TV channel to find whether it is free of any usage. In this case, a database comprising information on the TVWS usage can also be referred. The device performing channel allocation may be configured to contact a server keeping a database of the usage of TVWS channels. The transceiver may further sense the central 5 MHz of each TV channel to find whether WLAN transmission is operating on the channel. In an embodiment, the sensing may be performed by tuning to the desired band, measuring signal level on the band and comparing the obtained signal level to a given threshold. If the level is below the given threshold it may be determined that there is no traffic on the band.

In an embodiment, a base station such as an LTE eNodeB would operate in a single carrier manner over the aggregated available TV channels (as indicated by the TVWS database) wherein the central free resources 310 corresponding to ⅚ Physical Resource Blocks PRB are used for the downlink transmission of synchronization control channels and physical broadcast and random access channels PSS, SSS, PBCH and PRACH.

In an embodiment, the Physical Downlink Control Channel PDCCH are be transmitted over the central ⅚ PRBs and 2 PRBs on edges of available TV channel to schedule downlink grants for Physical Downlink Shared Channel PDSCH in downlink sub frames and uplink grants for Physical Uplink Control Channel PUCCH and Physical Uplink Shared Channel PUSCH in uplink sub frames.

In an embodiment, the Physical Downlink Shared Channel PDSCH is scheduled over the central ⅚ PRBs and 2 PRBs on edges of available TV channel if the available TV channels are not free of interference, or over all the PRBs in the available TVWS channels which are free of WLAN interference, in the downlink sub frames.

The Physical Uplink Shared Channel PUSCH may be scheduled over the central 2 PRBs on edges of available TV channel if available TV channels are not free of interference, or over all the PRBs not configured for uplink control channels in the available TVWS channels which are free of WLAN interference, in the uplink sub frames.

The Physical Uplink Control Channel PUCCH can be allocated with ⅔ PRBs bandwidth on each edge of the available TV channels, which are also free of WLAN interference. The location of the PUCCH resources can be informed to UEs via the configurations broadcasted in the central ⅚ PRBs and PUCCH resources can be scheduled via Downlink Control Information DCI format on PDCCH over the central ⅚ PRBs.

In an embodiment, user equipment of an LTE based system is con-figured to receive control and data signals on PDCCH where PDCCH is transmitted on an aggregation of several consecutive control channel elements (CCE). The aggregations follow a tree structure.

In an embodiment, the UE-specific search space for PDCCH may be configured via hashing function and mapping of contiguous Control Channel Elements CCE to available PRBs in the central ⅚ PRBs and 2 PRBs on edge of available TV channels with aggregation levels L=1, 2, 4, 8, for example.

Regarding user equipment, the user equipment only needs to do blind decoding in configured search space(s).

The Control Channel Elements may be mapped to PRBs within one TV channel (i.e. in central 3 PRBs and in 2 PRBs in edge of TV channel). This allows the scheduling of PDCCH on TV-channel basis in case only one TV channel available (i.e. no aggregated TV channels). The UE-specific search space may span more than one TV channels.

In case that all TV channels suffer from wireless local area network interference a fall-back mechanism may be utilized where an eNodeB indicates a new TV channel via broadcasted system information. The eNodeB may page UEs to indicate that a new system info needs to be read.

The proposed solution offers the transmission of essential LTE control channels in a robust and well protected manner. If WLAN trans-mission is present it utilizes Time Division Multiplexing TDM. Therefore idle periods may be used for LTE transmission. Even if WLAN is active, LTE may operate on limited resources for the non-interfered users. Load and admission control may be implemented to avoid the overload of the LTE system with limited protected control channel resources.

FIG. 4 is a flowchart illustrating an embodiment of the invention. The embodiment starts at step 400.

In step 402, a transceiver is controlled to determine free frequency blocks on a shared spectrum. As describe above, an example of the shared spectrum is television white spaces TVWS. The determination may be done by sensing traffic on the TV channels and/or searching one or more TVWS databases for channel usage information.

In step 404, a transceiver is controlled to map synchronization control channels, downlink and uplink physical control channels, physical broadcast channel and random access channel on found free frequency blocks.

The process ends in step 406.

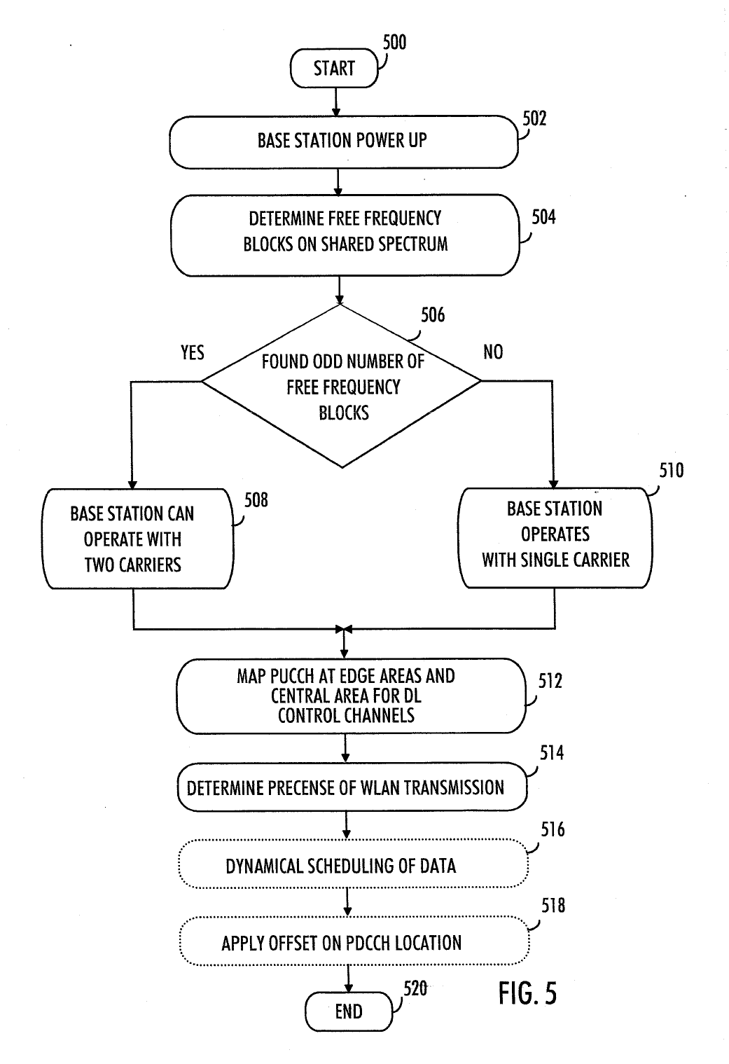

FIG. 5 is another flowchart illustrating an embodiment of the invention, where fractional free resources of WLAN occupying TV channels are utilized for LTE transmission. The embodiment starts at step 500.

In step 502, an eNodeB is powered on at a given site.

In step 504, the eNodeB determines free frequency blocks on a shared spectrum. As describe above, a non-limiting example of the shared spectrum is television white spaces TVWS. The determination may be done by sensing traffic on the TV channels and/or searching one or more TVWS databases for channel usage information.

In step 506, it is checked whether the number of found free TV channels M is even or odd.

In step 508, M is odd. In such a case, the eNodeB can operate with two carriers, (M−1)*6 MHz carrier and 6 MHz carrier with asymmetric carrier aggregation.

In step 510, M is even. In such a case, the eNodeB can operate with a single carrier over the bandwidth of M*6 MHz.

In step 512, 0.5 MHz frequency blocks at the two ends of each carrier is mapped for PUCCH and central 1 MHz (6 PRBs) for other downlink control channels. In case even M, the single carrier may be scheduled via normal scheduling, which uses control signaling mapped to the single carrier over the bandwidth of M*6 MHz. In case odd M, the single carrier may be scheduled via normal scheduling, which uses control signaling mapped to the single carrier over the bandwidth of (M−1)*6 MHz; and the left 6 MHz may be scheduled via cross-scheduling, which uses control signaling mapped to the single carrier over the bandwidth of (M−1)*6 MHz.

Primary synchronization channel PSS (comprising 62 subcarriers) and secondary synchronization channel SSS (comprising 62 subcarriers) with <1 Mhz frequency resources can be located in the middle of aggregated TV channels.

In step 514, the eNodeB is configured to determine the presence of WLAN transmission in the M TV channels by sensing the central 5 MHz within LTE operating carrier.

If WLAN presence is detected, the eNodeB may perform following operations for minimizing interference.

For avoiding interference on data channel transmission, the eNodeB may in step 516, apply dynamic scheduling based on WLAN interference measurement results made by the eNodeB or made by the LTE UEs and reported to the eNodeB. The dynamic scheduling allows eNodeB to schedule LTE UEs during time intervals where relatively small or no interference from WLAN is experienced.

For avoiding interference on control channel transmission (mainly on PDCCH), the eNodeB may in step 518 apply an offset on the location of PDCCH in the mapped bandwidth resource to a new location in the mapped bandwidth resource where relatively less interference can be expected based on the interference measurements. The offset value may be sent to the LTE UEs via Radio Resource Control RRC or by broadcasting.

The process ends in step 520.

Let us study the mapping of some control channels in more detail.

In LTE based systems, Physical Broadcast Channel PBCH is used to transmit system information for the UEs. The system information is grouped into information blocks, such as Master Information Block MIB and different System Information Blocks SIBs.

In an embodiment, Physical Broadcast Channel PBCH is transmitted in the middle of the WLAN-free resources. If the bandwidth of the WLAN-free resources is larger than 1.08 MHz, the eNode may operate the way as LTE by using the middle 6 PRBs.

If the bandwidth of the WLAN-free resources is below 1.08 MHz (typically 1 MHz), there are several options. For example, PBCH may be transmitted over the central 1 MHz and the edge 1 MHz in a distributed way. In addition, the current Master Information Block MIB message may be tailored to fit 1 MHz. For example, 10 spare bits in MIB [25.331] can be reduced for a smaller Transport Block.

In addition, puncturing may be increased in the physical layer to fit the PBCH into the available frequency blocks. In an embodiment, there is no need for any change in PBCH transmission since the WLAN is only interfering 0.8 MHz of the total 1.08 MHz. If needed, repetition of the broadcast information may be applied.

Physical Downlink Control Channel PDCCH is used for downlink scheduling and uplink scheduling grants. In an embodiment, a broadcast message or as RRC signaling may be used to configure the searching spaces of PDCCH. The common searching space can be configured on the interference free resources such as middle ⅚ PRBs+edge 2+2PRBs. A user specific searching space can be configured on one TV channel, the whole available bandwidth or hopping over TV channels.

In an embodiment, a pre-configured number of OFDM symbols may be mapped to PDCCH. This allows the PDCCH resources per UE to be more distributed in the time domain (OFDM symbols) and less dense in the frequency domain (PRBs) than the prior art 1 to 3 OFDM symbols available based on PCFICH. Using up to all the OFDM symbols in a sub frame for PDCCH allows more capacity for downlink control signaling in the central ⅚ and 2 PRBs on edge of available TV channel. This may be needed in case PDSCH or PUSCH can be scheduled in the available TV channels free of WLAN interference. The proposed way removes need for PCFICH. In case the eNodeB needs to do sensing, it may simply not schedule any PDCCH during the sensing interval—i.e. idle sub frames in downlink or uplink directions may readily be achieved by not scheduling any downlink or uplink grants. Alternatively, the last one or two symbols of a sub frame can be reserved for sensing without any resource mapping or transmission.

Physical Uplink Control Channel PUCCH is used for the transmission of uplink signaling data, such as HARQ signaling. PUCCH can be scheduled in two PRBs on the edges of TV channel free of WiFi interference. This allows a robust transmission of acknowledgement responses (ACK(NACK).

The resources for PUCCH need to be configured semistatically or via 3GPP LTE specifications based on TV channels.

An eNodeB can sense the transmission of WLAN in a TV channel via Clear Channel Assessment Energy Detection CCA-ED specified in WLAN standards and known to one skilled in the art. If a TV channel is free of Wireless local area transmission longer than a given predetermined time interval then the eNodeB can use resource for data transmission.

In an embodiment, an eNodeB can make sensing during Uplink sub frames assuming LTE TDD. The eNodeB doesn't schedule any UEs during quiet uplink sub frames (no PUSCH, no PUCCH).

In an embodiment, an eNodeB will not schedule anything in a TV channel occupied by WLAN to avoid interfering with WLAN transmission.

In an embodiment, an eNodeB located in the WLAN cell edge may schedule some traffic with less power and/or small bandwidth to minimize interference to WLAN channel.

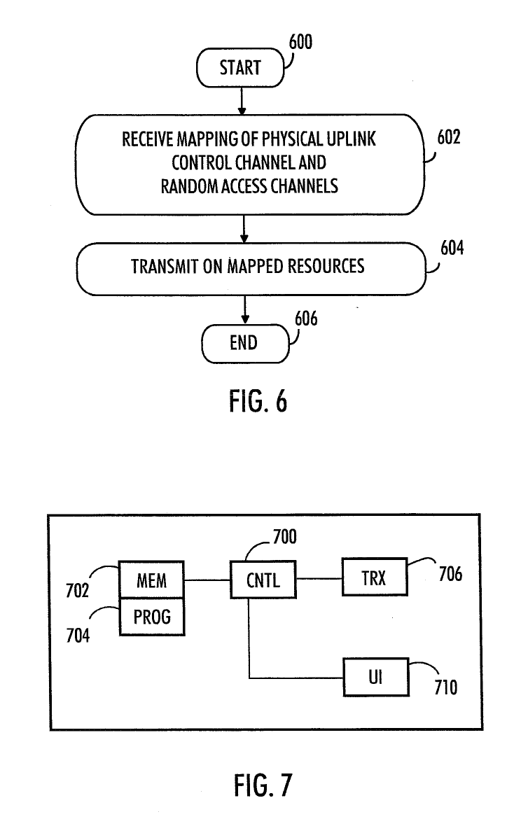

FIG. 6 is a flowchart illustrating an embodiment from the UE point of view. The embodiment starts in step 600.

In step 602, the UE receives from an eNodeB the mapping of a physical uplink control channel and random access channels on frequency blocks of a shared spectrum. In LTE based systems the physical uplink control channel is PUCCH. In an embodiment, the PUCCH resources and RACH are be mapped to two PRBs on edges of available TV channel as indicated by DCI format transmitted in the central ⅚ PRBs. In another embodiment, for periodic Scheduling Request and periodic Channel Quality Information (CQI), PUCCH resources may be scheduled via dedicated Radio Resource Configuration (RRC) signaling—i.e. not via DCI format on Physical Downlink Control Channel.

In step 604, the UE communicates with the eNodeB on the physical uplink control channel and random access channels on the frequency blocks of the shared spectrum on the basis of the received mapping.

The process ends in step 606.

FIG. 7 illustrates an embodiment. The figure illustrates a simplified example of a device in which embodiments of the invention may be applied. In some embodiments, the device may be user equipment UE or a respective device communicating with a base station or an eNodeB of a communications system.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 700 configured to control at least part of the operation of the device.

The device may comprise a memory 702 for storing data. Furthermore the memory may store software 704 executable by the control circuitry 700. The memory may be integrated in the control circuitry.

The device comprises a transceiver 706. The transceiver is operationally connected to the control circuitry 700. It may be connected to an antenna arrangement (not shown).

The software 704 may comprise a computer program comprising program code means adapted to cause the control circuitry 700 of the device to control a transceiver 706 to control the transceiver 706 to receive the mapping of synchronization control channels and physical broadcast and random access channels on frequency blocks of a shared spectrum, and control the transceiver to communicate on the synchronization control channels and physical broadcast and random access channels on the frequency blocks of the shared spectrum on the basis of the received mapping.

The device may further comprise user interface 710 operationally connected to the control circuitry 700. The user interface may comprise a display which may be touch sensitive, a keyboard or keypad, a microphone and a speaker, for example.

In an embodiment, an apparatus comprises means for controlling a transceiver to determine free frequency blocks on a shared spectrum and means for controlling a transceiver to map synchronization control channels, downlink and uplink physical control channels, physical broadcast channel and random access channel on found free frequency blocks.

In an embodiment, an apparatus comprises means for controlling a transceiver to receive the mapping of a physical uplink control channel and random access channels on frequency blocks of a shared spectrum, and means for controlling a transceiver to communicate on the physical uplink control channel and random access channels on the frequency blocks of the shared spectrum on the basis of the received mapping.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, or a circuitry which may comprise a working memory (RAM), a central processing unit (CPU), and a system clock. The CPU may comprise a set of registers, an arithmetic logic unit, and a controller. The controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claim.

1. An apparatus in a communication system, comprising:
at least one processor; and
at least one memory including computer program code,
the at least one memory and the computer program code configured to, with the at least one processor, cause the apparatus at least to perform:
control a transceiver to determine free frequency blocks on a shared spectrum;
control a transceiver to map synchronization control channels, downlink and uplink physical control channels, physical broadcast channel and random access channel on found free frequency blocks.

2. The apparatus of claim 1, the apparatus being configured to control a transceiver to identify wireless local area network channels of a given frequency band on the shared spectrum and control the transceiver to select frequency blocks located between the identified unused wireless local area network channels for transmission.

3. The apparatus of claim 1, the apparatus being configured to control the transceiver to utilize a shared spectrum comprising television channels having a first bandwidth, wherein wireless local area network transmissions may be operated on a television channel, the wireless local area network transmission being located in the middle of a television channel and having a second bandwidth which is smaller than the first band by a given frequency block.

4. The apparatus of claim 3, the apparatus being configured to control the transceiver to sense the edge of one or more television channels for television transmission and the center of one or more television channels for wireless local area network transmission.

5. The apparatus of claim 3, the apparatus being configured to determine the usage of television channels for television transmission from a database.

6. The apparatus of claim 1, the apparatus being configured to receive interference measurement results, and utilize the received measurement results when selecting timing of data transmission.

7. The apparatus of claim 3, the apparatus being configured to determine the number M of free television channels, and operate on a single carrier having a bandwidth of M times the first bandwidth, if the number M is even and operate with two carriers with bandwidths (M−1)*the first bandwidth and the first bandwidth with asymmetric carrier aggregation, if the number M is odd.

8. An apparatus in a communication system, comprising:
at least one processor; and
at least one memory including computer program code,
the at least one memory and the computer program code configured to, with the at least one processor, cause the apparatus at least to perform:
control a transceiver to receive the mapping of a physical uplink control channel and random access channels on frequency blocks of a shared spectrum,
control a transceiver to communicate on the physical uplink control channel and random access channels on the frequency blocks of the shared spectrum on the basis of the received mapping.

9. The apparatus of claim 8, the apparatus being configured to measure interference on given frequency blocks of a shared spectrum,
send measurement results to a base station;
receive data scheduling information from the base station.

10. A method in a communication system, comprising:
controlling a transceiver to determine free frequency blocks on a shared spectrum and
controlling a transceiver to map synchronization control channels, downlink and uplink physical control channels, physical broadcast channel and random access channel on found free frequency blocks.

11. The method of claim 10, further comprising: controlling a transceiver to identify wireless local area network channels of a given frequency band on the shared spectrum and control the transceiver to select frequency blocks located between the identified unused wireless local area network channels for transmission.

12. The method of claim 10, further comprising: controlling the transceiver to utilize a shared spectrum comprising television channels having a first bandwidth, wherein wireless local area network transmissions may be operated on a television channel, the wireless local area network transmission being located in the middle of a television channel and having a second bandwidth which is smaller than the first band by a given frequency block.

13. The method of claim 12, further comprising: controlling the transceiver to sense the edge of one or more television channels for television transmission and the center of one or more television channels for wireless local area network transmission.

14. The method of claim 12, further comprising: determining the usage of television channels for television transmission from a database.

15. The method of claim 10, further comprising: receiving interference measurement results, and utilizing the received measurement results when selecting timing of data transmission.

16. A method in a communication system, comprising:
controlling a transceiver to receive the mapping of a physical uplink control channel and random access channels on frequency blocks of a shared spectrum,
controlling a transceiver to communicate on the physical uplink control channel and random access channels on the frequency blocks of the shared spectrum on the basis of the received mapping.

17. The method of claim 16, further comprising: measuring interference on given frequency blocks of a shared spectrum, sending measurement results to a base station; and receiving data scheduling information from the base station.

18. A computer program product embodied on a distribution medium readable by a computer and comprising program instructions which, when loaded into an apparatus, execute a computer process comprising: controlling a transceiver to determine free frequency blocks on a shared spectrum and controlling a transceiver to map synchronization control channels and physical broadcast and random access channels on found free frequency blocks.

19. A computer program product embodied on a distribution medium readable by a computer and comprising program instructions which, when loaded into an apparatus, execute a computer process comprising: controlling a transceiver to receive the mapping of a physical uplink control channel and random access channels on frequency blocks of a shared spectrum,
controlling a transceiver to communicate on the physical uplink control channel and random access channels on the frequency blocks of the shared spectrum on the basis of the received mapping.
